(19) United States
(12) Patent Application Publication
(10) Pub. No.: US 2012/0240341 A1
(43) Pub. Date: Sep. 27, 2012

(54) Combination Tool

(76) Inventor: Wen Hung Chiang, Taichung (TW)

(21) Appl. No.: 13/065,439

(22) Filed: Mar. 22, 2011

(51) Int. Cl. B25F 1/00

(52) U.S. Cl. 7/138

(57) ABSTRACT

A combination tool includes a handle having an enlarged head used as a striking tool, and having a chamber formed in the head for rotatably receiving a follower, and a pawl pivotally attached to the handle and having two engaging members for selectively engaging with the follower and for determining a rotational movement of the follower relative to the handle and for forming a ratchet wrench tool, and a tool member changeably disposed on the other end portion of the handle for conducting various kinds of works, a spring-biased projection is engaged in the handle and biased to engage with the pawl for anchoring either of the engaging members in engagement with the follower.

### BACKGROUND OF THE INVENTION

1. Field of the Invention

The present invention relates to a combination tool, and more particularly to a combination tool or tool combination including a structure for being used as a hammer, a wrench and the other tool devices and for allowing the user to easily conduct or operate various kinds of works.

2. Description of the Prior Art

Typical combination tools or tool combinations comprise two or more kinds of tool members or tool elements for being used as two or more kinds of working or machining actuations or operations.

For example, U.S. Pat. No. 4,268,927 to Bridwell discloses one of the typical combination tools which may be used as a hammer, impact device, and screw driver.

However, the typical combination tool may not be used as a ratchet wrench for rotating or driving various kinds of tool members or tool elements or fasteners.

U.S. Pat. No. 4,548,278 to Gidlund, and U.S. Pat. No. 6,009,626 to Lei disclose two further typical percussion tools that may be used as a percussion tool only, but may not be used as the other typical tools.

U.S. Pat. No. 5,657,674 to Burnett, U.S. Pat. No. 5,768,956 to Coonrad, and U.S. Pat. No. 5,916,338 to Bergkvist et al. disclose three further typical percussive tools or striking tools that may be used as a percussive tool or a striking tool only, but may not be used as the other typical tools.

U.S. Pat. No. 6,341,544 to Falzone discloses a further typical wrench that may be used as a wrench only, but may not be used as the other typical tools.

The present invention has arisen to mitigate and/or obviate the afore-described disadvantages of the conventional combination tools.

### SUMMARY OF THE INVENTION

The primary objective of the present invention is to provide a combination tool including a structure for being used as a hammer, a wrench and the other tool devices and for allowing the user to easily conduct or operate various kinds of works.

In accordance with one aspect of the invention, there is provided a combination tool comprising a handle including an enlarged head provided on a first end portion thereof for being used as a striking tool, and including a chamber formed in the head, and including a second end portion, a follower rotatably received and engaged in the chamber of the head and including an engaging element provided therein, a pawl pivotally attached to the handle with a pivot shaft for pivoting relative to the handle, and including two engaging members for selectively engaging with the follower and for determining a rotational movement of the follower relative to the handle and for forming a ratchet wrench tool, and a tool member provided on the second end portion of the handle.

The handle includes a compartment formed therein and communicative with the chamber of the head for receiving the pawl. The handle includes a spring-biased projection biased to engage with the pawl for anchoring either of the engaging members in engagement with the follower.

The follower includes a gear provided on an outer peripheral portion thereof for engaging with the engaging members. The handle includes a retaining device attached to the second end portion for selectively securing the tool member to the handle.

The retaining device includes a spring-biased stem slidably engaged in the second end portion of the handle for engaging with a detent and for selectively actuating the detent to engage with the tool member, and a barrel slidably attached to the second end portion of the handle and coupled to the stem for moving the stem relative to the handle.

The tool member includes an orifice formed therein for receiving the second end portion of the handle, and includes a cavity formed therein and communicative with the orifice thereof for engaging with the detent. The tool member may be selected from a screw driver and a chisel or the like.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a combination tool in accordance with the present invention;

FIG. 2 is a partial exploded view of the combination tool;

FIGS. 3, 4 are partial cross sectional views of the combination tool, taken along lines 3-3 and 4-4 of FIG. 1 respectively;

FIG. 5 is a partial exploded and partial cross sectional view of the combination tool;

FIGS. 6 and 7 are partial exploded views illustrating the operation of the combination tool;

FIGS. 8, 9 are perspective views illustrating the operation of the combination tool;

FIG. 10 is another partial exploded and partial cross sectional view illustrating the other arrangement of the combination tool;

FIG. 11 is a further partial exploded view illustrating the operation of the combination tool; and

FIGS. 12, 13 are perspective views illustrating the operation of the combination tool.

### DETAILED DESCRIPTION OF THE PREFERRED EMBODIMENT

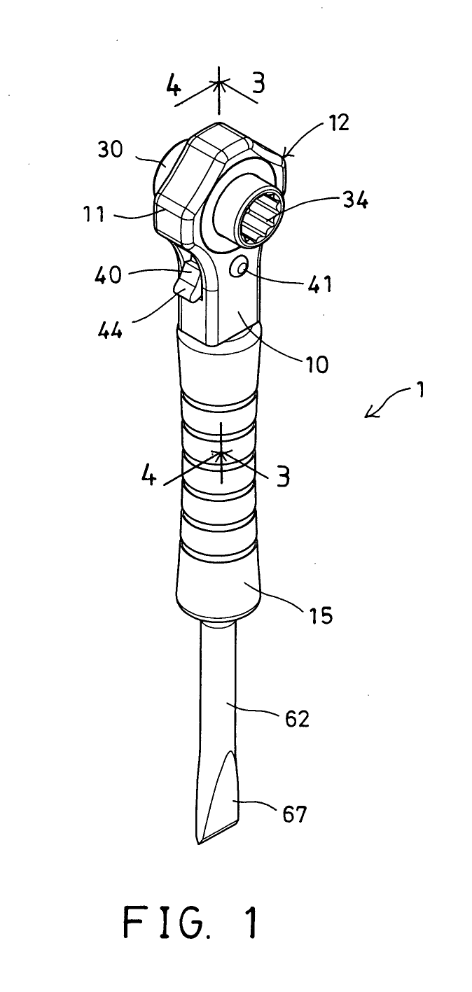

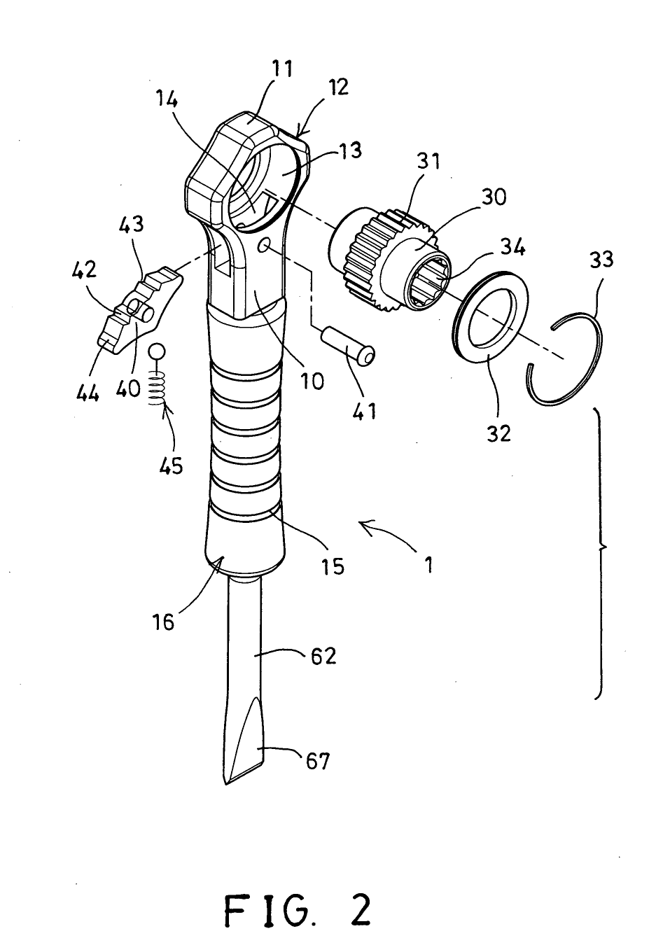

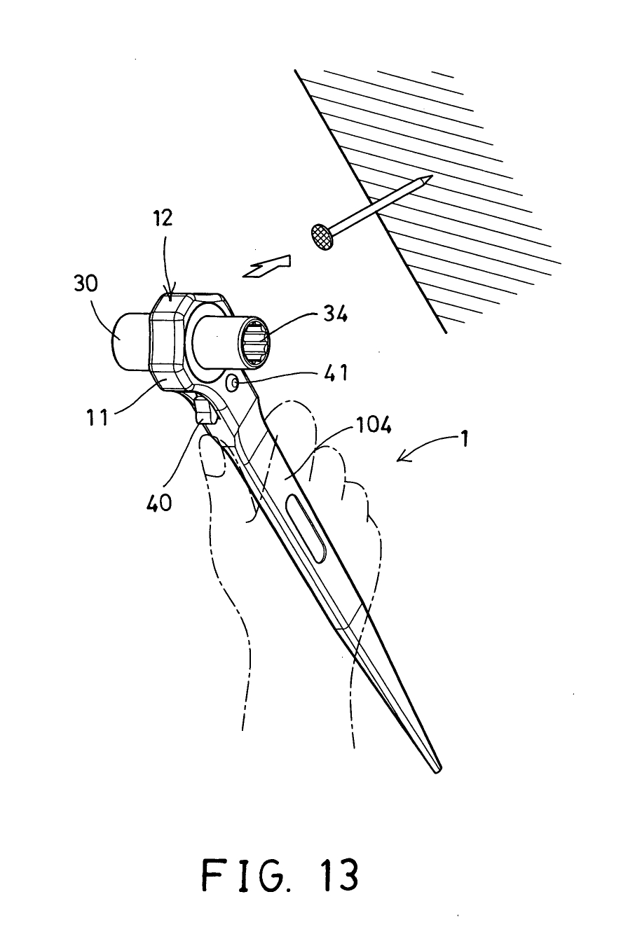

Referring to the drawings, and initially to FIGS. 1-5, a combination tool 1 in accordance with the present invention comprises a longitudinal arm or handle 10 including an enlarged head 11 formed or provided on one end or first end portion 12 thereof for being used as a hammer or a percussive tool or a striking tool as shown in FIG. 13, and including a chamber 13 formed therein, such as formed in the one end portion 12 or the head 11 thereof for pivotally or rotatably receiving or engaging with a driven member or follower 30, and including a compartment 14 formed therein, such as formed in the one end portion 12 or formed in the handle 10 and intersecting or communicative with the chamber 13 of the head 11 or of the handle 10 for pivotally or rotatably receiving or engaging with a pawl 40.

The follower 30 is pivotally or rotatably received or engaged in the chamber 13 of the head 11 or of the handle 10, and includes a gear 31 formed or provided on outer peripheral portion thereof, and pivotally or rotatably attached or mounted or secured to the head 11 or the handle 10 with a washer 32 and/or a clamping or retaining ring 33 such that the follower 30 may be pivotally or rotatably received or contained or confined or retained in the head 11 of the handle 10. The follower 30 includes an engaging element 34, such as a socket opening 34 formed or provided therein (FIGS. 1-2, 4, 6, and 11-13) for receiving or engaging with various kinds of tool members or tool elements or fasteners (not shown).

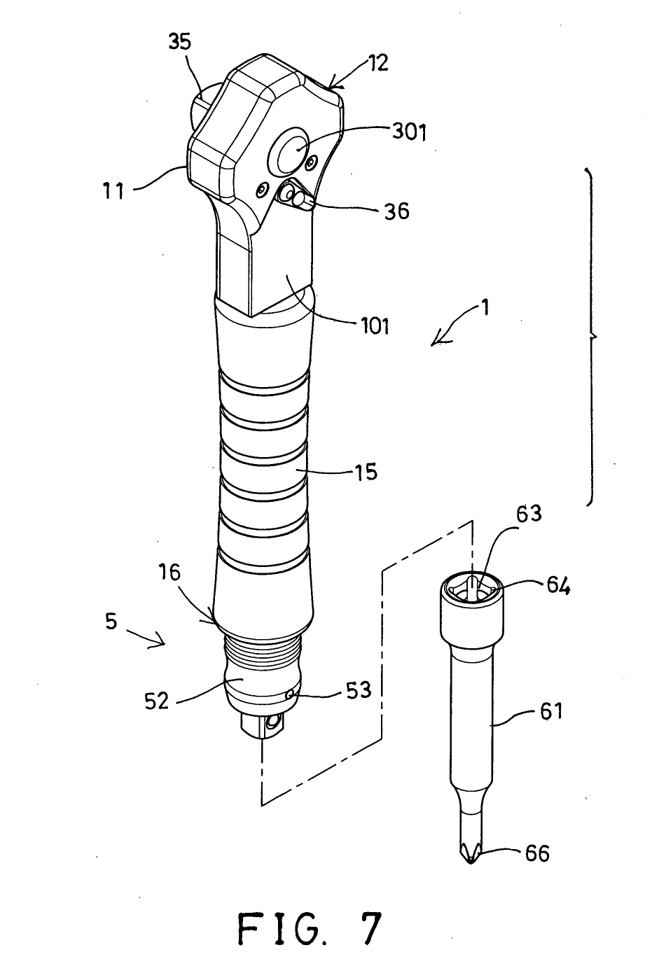

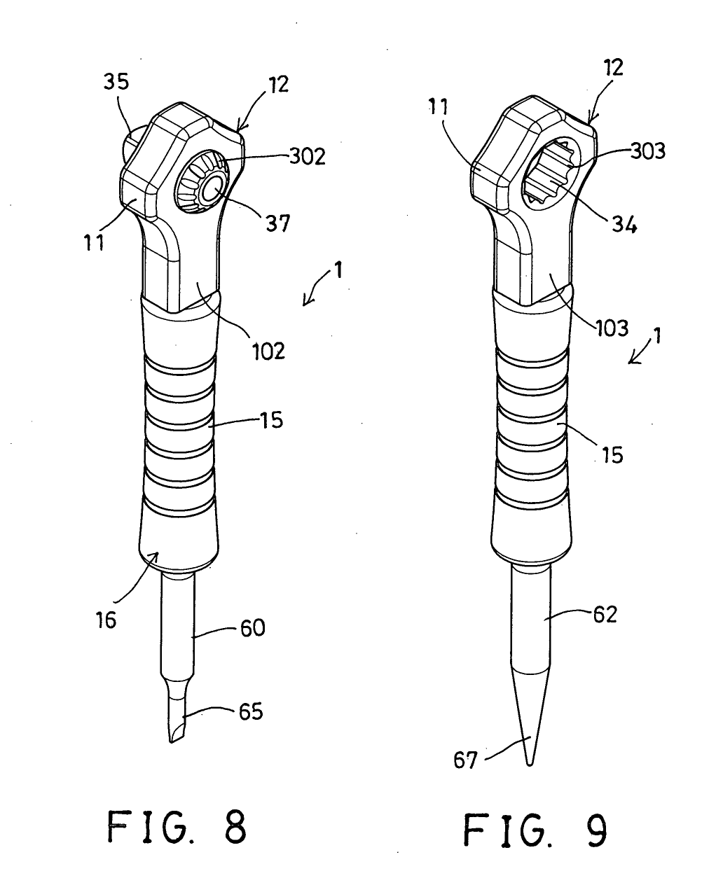

Alternatively, as shown in FIG. 7, the handle 101 may include another type of follower 301, such as a driving shank 35 pivotally or rotatably attached or mounted or secured to the handle 101 with a knob 36 and a ratchet mechanism (not shown). Or, as shown in FIG. 8, the handle 102 may include a further type of follower 302 having a driving shank 35 pivotally or rotatably attached or mounted or secured to the handle 102 with a ratchet mechanism (not shown) and a depressing knob 37. Or, as shown in FIG. 9, the handle 103 may include a still further type of follower 303 also having a socket opening 34 formed therein, but the follower 303 is flush with the head 11 of the handle 103, or is not extended out of the head 11 of the handle 103.

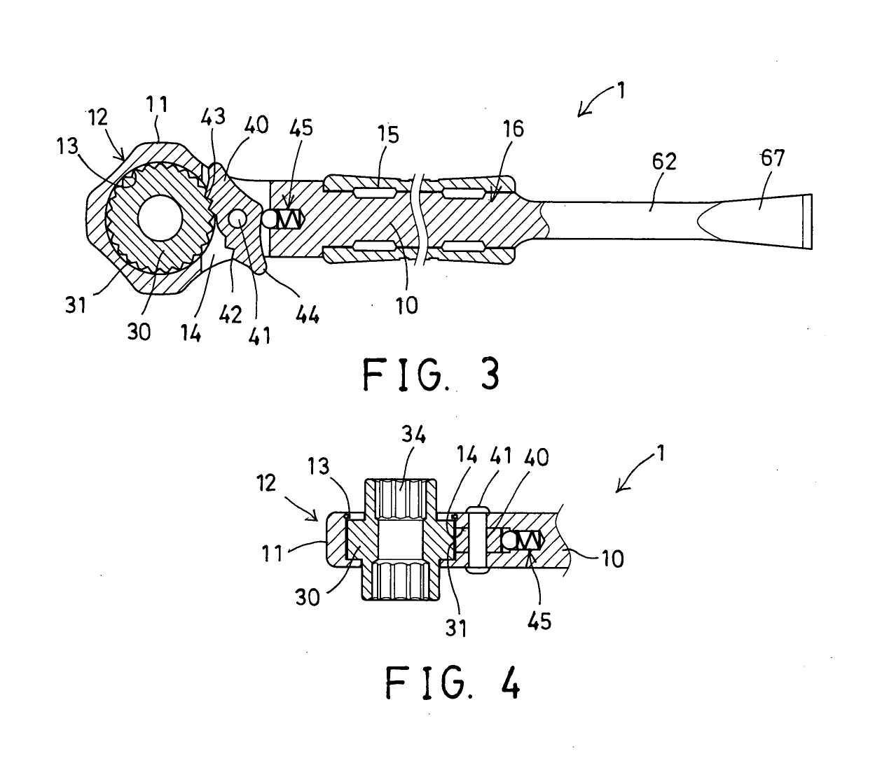

The pawl 40 is pivotally or rotatably received or engaged in the compartment 14 of the handle 10, and pivotally or rotatably attached or mounted or secured to the handle 10 with a pivot shaft 41 for allowing the pawl 40 to be pivoted or rotated relative to the handle 10 and the follower 30, and includes two teeth or engaging members 42, 43 for selectively engaging with the gear 31 of the follower 30 and for limiting or determining the rotational movement of the follower 30 relative to the handle 10 and for forming a ratchet wrench structure or tool (FIGS. 3-5 and 10). A spring-biased projection 45 is received or engaged in the handle 10 and biased to engage with the pawl 40 for anchoring or securing or retaining either of the engaging members 42, 43 in engagement with the gear 31 of the follower 30.

As shown in FIGS. 1, 3, 5-6, the pawl 40 includes two end portions 44 extended out of the handle 10 for being depressed or moved or switched or operated to actuate either of the engaging members 42, 43 to selectively engage with the gear 31 of the follower 30, in order to limit or to determine the driving or rotational movement of the follower 30 relative to the handle 10. Accordingly, the combination tool may also be used as a ratchet wrench in addition to the hammer or percussive tool or striking tool. The handle 10 may include a soft outer covering 15 attached or mounted or secured onto the outer peripheral portion thereof for being softly and comfortably grasped or held and operated by the user. Alternatively, as shown in FIGS. 12-13, no soft outer covering is attached or mounted or secured onto the handle 104.

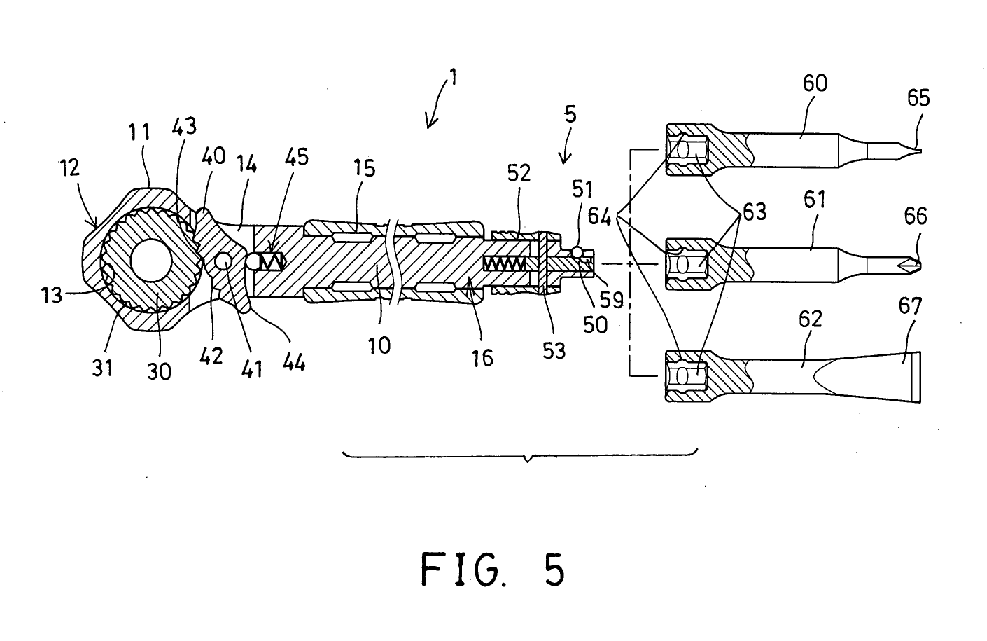

Referring to FIGS. 5-7, the handle 10, 101 may include a retaining device 5 attached or mounted or secured to the other end portion 16 of the handle 10, 101 for selectively or changeably anchoring or securing or retaining various tool members 60, 61, 62 to the handle 10, 101. For example, as shown in FIG. 5, the handle 10 includes a spring-biased stem 50 slidably received or engaged in the other end portion 16 thereof for engaging with a detent 51 and for selectively actuating the detent 51 to engage with the tool members 60, 61, 62, and a sleeve or barrel 52 slidably attached or mounted or secured to the other end portion 16 of the handle 10 and connected or coupled to the stem 50 with a linking rod 53 for moving the stem 50 relative to the handle 10.

The stem 50 includes a recess 59 formed therein for selectively receiving or engaging with the detent 51 and for allowing the detent 51 to be selectively disengaged from the tool members 60, 61, 62, and the spring-biased stem 50 may actuate the detent 51 to selectively engage with the tool members 60, 61, 62 when the barrel 52 is released. The tool members 60, 61, 62 each include an orifice 63 formed therein for selectively receiving or engaging with the other end portion 16 of the handle 10, and each include a cavity 64 formed therein and communicative with the orifice 63 thereof for selectively receiving or engaging with the detent 51 and for allowing the tool members 60, 61, 62 (FIGS. 1-3, 5-9) to be selectively attached or mounted to or disengaged from the handle 10. The tool members 60, 61, 62 may be selected from a flat screw driver 65, a Philippe screw driver 66, a chisel 67 or the like.

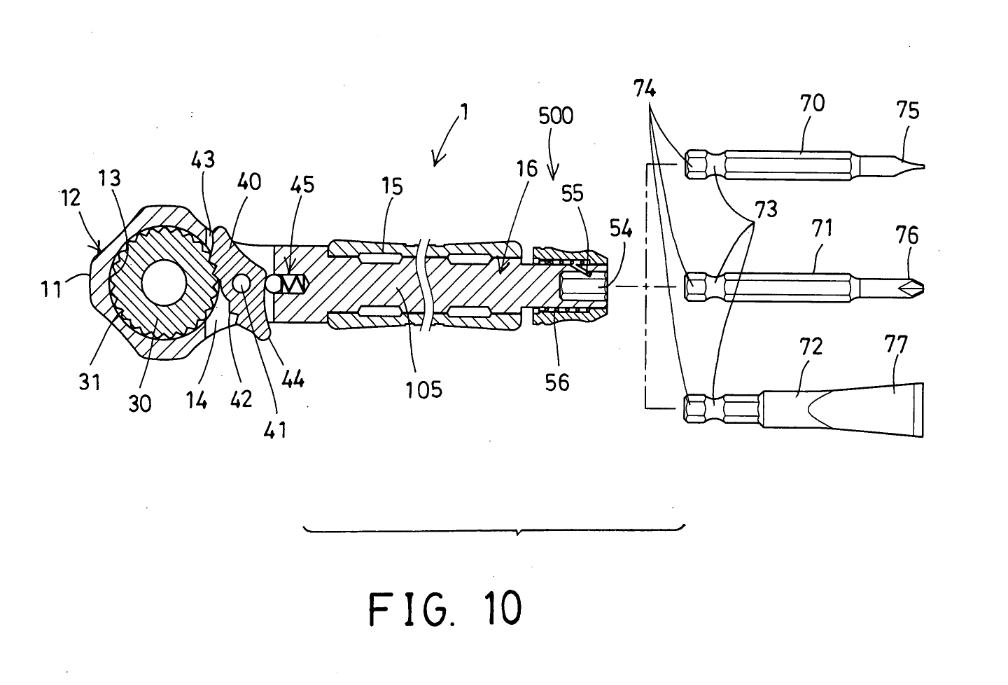

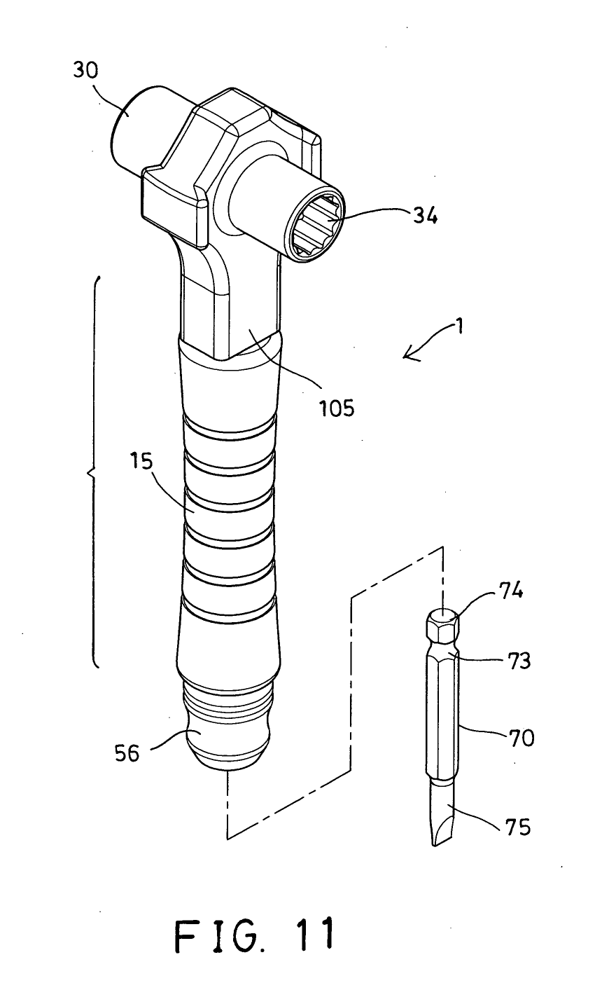

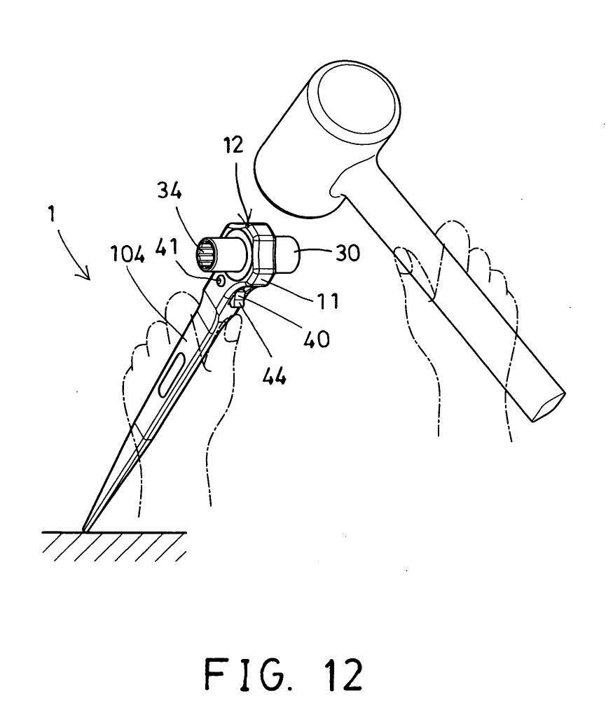

Further alternatively, as shown in FIGS. 10-11, the handle 105 may include an engaging hole 54 formed in the other end portion 16 of the handle 105, and another retaining device 500 includes a spring member 55 attached or mounted or secured to the other end portion 16 of the handle 105 and selectively engageable into the engaging hole 54 for selectively or changeably engaging with and for anchoring or securing or retaining various tool elements 70, 71, 72 to the handle 105, a barrel or sleeve 56 is engaged with the spring member 55 for selectively actuating the spring member 55 to engage with the tool elements 70, 71, 72. The tool elements 70, 71, 72 each include a recess or depression 73 formed in one end portion 74 thereof for selectively engaging into the engaging hole 54 of the handle 105 and for being selectively or changeably anchored or secured or retained to the handle 105 with the spring member 55. The tool elements 70, 71, 72 may also be selected from various kinds of tool elements, such as a flat screw driver 75, a Philippe screw driver 76, a chisel 77 or the like.

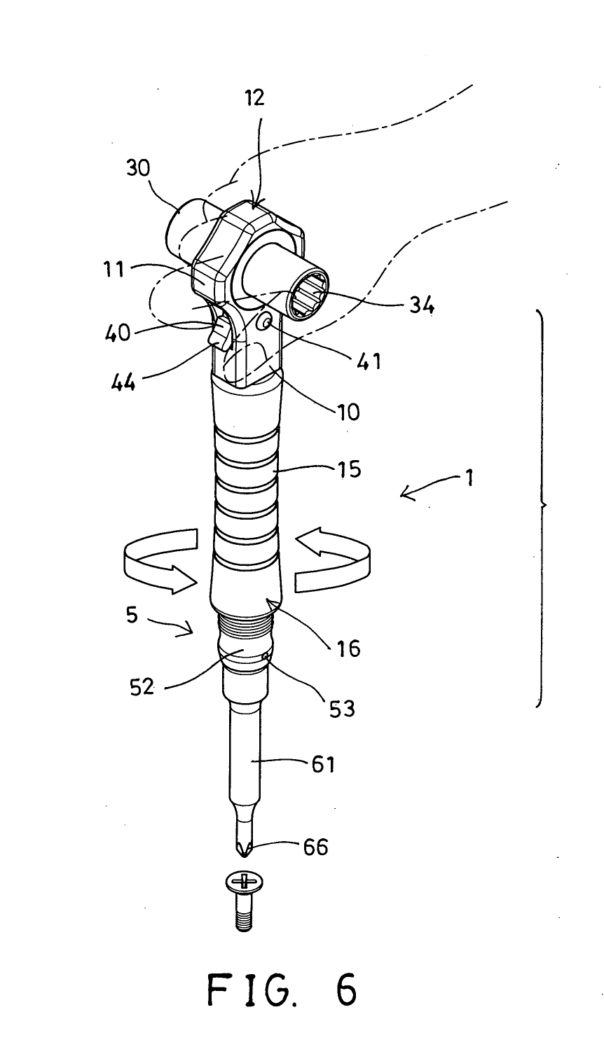

In operation, as shown in FIG. 12, the combination tool 1 may be used as a chisel, or may be used as a hammer as shown in FIG. 13, or may be used as a screw driver as shown in FIG. 6, or may be used as a ratchet wrench as shown in FIGS. 1-13, such that the user may easily conduct various kinds of works, such as digging holes in the work pieces, or rotating or driving various kinds of tool members or tool elements or fasteners with a single combination tool.

Accordingly, the combination tool in accordance with the present invention includes a structure for being used as a hammer, a ratchet wrench and the other tool devices and for allowing the user to easily conduct or operate various kinds of works.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A combination tool comprising:
a handle including an enlarged head provided on a first end portion thereof for being used as a striking tool, and including a chamber formed in said head, and including a second end portion,
a follower rotatably received and engaged in said chamber of said head and including an engaging element provided therein,
a pawl pivotally attached to said handle with a pivot shaft for pivoting relative to said handle, and including two engaging members for selectively engaging with said follower and for determining a rotational movement of said follower relative to said handle and for forming a ratchet wrench tool, and
a tool member provided on said second end portion of said handle.

2. The combination tool as claimed in claim 1, wherein said handle includes a compartment formed therein and communicative with said chamber of said head for receiving said pawl.

3. The combination tool as claimed in claim 1, wherein said handle includes a spring-biased projection biased to engage with said pawl for anchoring either of said engaging members in engagement with said follower.

4. The combination tool as claimed in claim 1, wherein said follower includes a gear provided on an outer peripheral portion thereof for engaging with said engaging members.

5. The combination tool as claimed in claim 1, wherein said handle includes a retaining device attached to said second end portion of said handle for selectively securing said tool member to said handle.

6. The combination tool as claimed in claim 5, wherein said retaining device includes a spring-biased stem slidably engaged in said second end portion of said handle for engaging with a detent and for selectively actuating said detent to engage with said tool member, and a barrel slidably attached to said second end portion of said handle and coupled to said stem for moving said stem relative to said handle.

7. The combination tool as claimed in claim 6, wherein said tool member includes an orifice formed therein for receiving said second end portion of said handle, and includes a cavity formed therein and communicative with said orifice thereof for engaging with said detent.

8. The combination tool as claimed in claim 1, wherein said tool member is selected from a screw driver and a chisel.
